(19) United States
(12) Patent Application Publication
(10) Pub. No.: US 2022/0025822 A1
(43) Pub. Date: Jan. 27, 2022

(54) DOUBLE-FLOW TURBOJET ENGINE ASSEMBLY WITH EPICYCLOIDAL OR PLANETARY REDUCTION GEAR

(71) Applicant: SAFRAN AIRCRAFT ENGINES, Paris (FR)

(72) Inventors: Alexandre Jean-Marie TAN-KIM, Moissy-Cramayel (FR); Yanis BENSLAMA, Moissy-Cramayel (FR); Jérémy DIEVART, Moissy-Cramayel (FR); Julien Fabien Patrick BECOULET, Moissy-Cramayel (FR)

(21) Appl. No.: 17/297,076

(22) PCT Filed: Nov. 21, 2019
(86) PCT No.: PCT/FR2019/052778

§ 371 Date: May 26, 2021

(51) Int. Cl. F02C 7/36; F02C 7/06

(52) U.S. Cl. CPC F02C 7/36; F05D 2240/50; F05D 2260/40311; F02C 7/06

(57) ABSTRACT

A turbojet engine including a central shaft surrounded by a coaxial and independent high-pressure body, the turbojet engine including, from upstream to downstream: —a fan driven by the central shaft; a high-pressure compressor and a high-pressure turbine supported by the high-pressure body; an inter-turbine housing; a low-pressure turbine; and an exhaust housing. The turbojet engine also includes: a low-pressure rotor which extends downstream of the central shaft and supports the low-pressure turbine; a rotor bearing supported by the exhaust housing; a reduction gear by which the low-pressure rotor drives the central shaft, the reduction gear being located upstream of the rotor bearing; and a downstream shaft bearing which is located upstream of the reduction gear.

### TECHNICAL FIELD

The invention relates to a twin-spool turbojet assembly including an epicycloidal or planetary reduction gear.

### PRIOR ART

In such an engine 1 shown in FIG. 1, the air is admitted into an inlet sleeve 2 in order to pass through a fan 3 including a series of rotary blades before dividing into a central primary flow and a secondary flow surrounding the primary flow.

The primary flow is next compressed in compression stages 4 and 6 before arriving in a combustion chamber 7, after which it is expanded through a high-pressure turbine 8 and a low-pressure turbine 9 before being discharged towards the rear. The secondary flow is for its part propelled directly towards the rear by the fan in a duct delimited by the casing 11.

Such an engine of the twin-spool type includes a so-called low-pressure spool by means of which the fan 3 is coupled to the low-pressure turbine, and a so-called high-pressure spool by means of which the compressor is coupled to the high-pressure turbine, these two spools being coaxial and independent of each other in rotation.

By means of a reduction gear interposed between the low-pressure turbine and the fan, the low-pressure turbine rotates more quickly than the fan that it drives, in order to increase the efficiency. In this configuration, the low-pressure spool includes a central shaft for driving the fan and a rotor carrying the low-pressure turbine while being connected to the central shaft by the reduction gear.

The high-pressure and low-pressure spools are held by bearings carried by structural elements of the engine. In practice, the low-pressure spool is a critical element of the assembly, since the central shaft thereof extends substantially over the entire length of the engine, so that in service, that is to say when it rotates, it may be subject to vibratory modes liable to lead to the ruin of the engine. In particular, because of its great length, the first bending vibration mode of the central shaft is in its operating range, that is to say in the range of frequencies corresponding to its rotation frequencies.

This situation requires achieving a balancing at high speed of the central shaft, but also providing bearings capable of damping its vibratory modes in order to limit any instabilities. Such bearings, generally designated by the acronym SFD, “squeeze film dampers”, include a fixed flexible cage carrying a rolling bearing receiving the low-pressure spool, and around which a hydraulic pressure is maintained, this type of bearing being expensive to implement.

The aim of the invention is to provide assembly solutions making it possible to improve the holding of the low-pressure rotary elements to limit recourse to complex bearings for damping vibratory modes.

### DESCRIPTION OF THE INVENTION

For this purpose, the object of the invention is a twin-spool turbojet engine including a central shaft surrounded by a high-pressure spool that are coaxial and independent with respect to rotation, this turbojet engine including, from upstream to downstream considered in the direction of travel of the flow that passes through it when it is in service:
a fan driven by the central shaft;
a high-pressure compressor and a high-pressure turbine forming part of the high-pressure spool;
an interturbine casing;
a low-pressure turbine;
an exhaust casing;

this turbojet engine further including:
a low-pressure rotor extending downstream of the central shaft and which comprises the low-pressure turbine;
a rotor bearing carried by the exhaust casing, and which rotationally guides the low-pressure rotor;
a reduction gear by means of which the low-pressure rotor drives the central shaft, this reduction gear being located upstream of the rotor bearing;
a downstream shaft bearing that rotationally guides the central shaft while being located upstream of the reduction gear.

With this arrangement, the speed of the central shaft is reduced, which contributes to reducing the frequencies of its natural modes in order to move them away from the rotation frequencies. The reduction of this speed of the central shaft also makes it possible to increase the diameter of the fan without the speed at the end of the blades of this fan being excessive.

Another object of the invention is a turbojet engine thus defined, wherein the downstream shaft bearing is carried by the interturbine casing.

Another object of the invention is a turbojet engine thus defined, wherein the reduction gear is an epicycloidal reduction gear comprising:
planet gears carried by a planet holder that is carried by the central shaft;
an inner ring that is carried by the low-pressure rotor;
an outer ring that is carried by the interturbine casing;
each planet gear being meshed with the inner ring and with the outer ring.

Another object of the invention is a turbojet engine thus defined, wherein the reduction gear is a planetary reduction gear comprising:
planet gears carried by a planet carrier that is carried by the interturbine casing;
an inner ring that is carried by the low-pressure rotor;
an outer ring that is carried by the central shaft;
each planet gear being meshed with the inner ring and with the outer ring.

Another object of the invention is a turbojet engine thus defined, including a low-pressure compressor driven by the central shaft while being located between the fan and the high-pressure compressor.

### BRIEF DESCRIPTION OF THE DRAWINGS

FIG. 1 is a view in longitudinal section of a known double-flow twin-spool turbojet engine;

FIG. 2 is a schematic view in longitudinal section of a turbojet engine architecture according to the invention;

FIG. 3 is a schematic view in longitudinal section of a downstream portion of turbojet engine architecture according to a first embodiment of the invention;

FIG. 4 is a schematic view in longitudinal section of a downstream portion of turbojet engine architecture according to a second embodiment of the invention.

### DETAILED DESCRIPTION OF PARTICULAR EMBODIMENTS

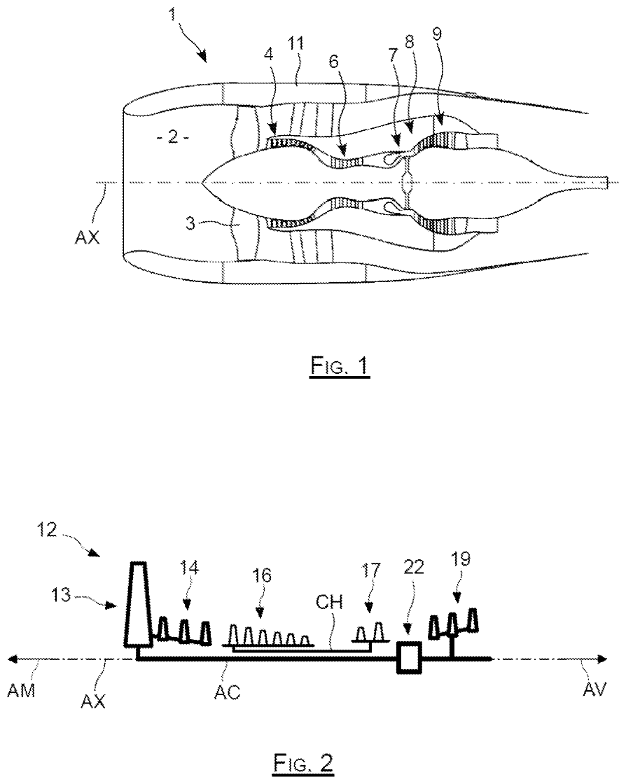

As shown schematically in FIG. 2, the engine according to the invention has an architecture comprising a fan 13 at the upstream part AM thereof followed by a low-pressure compressor 14. This fan 13 and this low-pressure compressor 14 are rotated by a central shaft AC extending over most of the length of the engine, the fan 13 having the whole of the flow that enters this engine pass through it, flowing from the upstream end AM to the downstream end AV.

A high-pressure compressor 16 located immediately downstream AV of the compressor 14 compresses the fluid of the primary flow that has passed through the low-pressure compressor, before admission thereof in the combustion chamber, not shown, located immediately downstream of this high-pressure compressor 16.

After passing through the combustion chamber, the fluid is expanded through a high-pressure turbine 17, which drives the compressor 16. The bladings of the high-pressure compressor 16 and of the high-pressure turbine 17 are carried by the same high-pressure body CH. This high-pressure body CH lies in the central region of the engine along the axis AX, it surrounds the central shaft AC while being completely rotationally independent thereof.

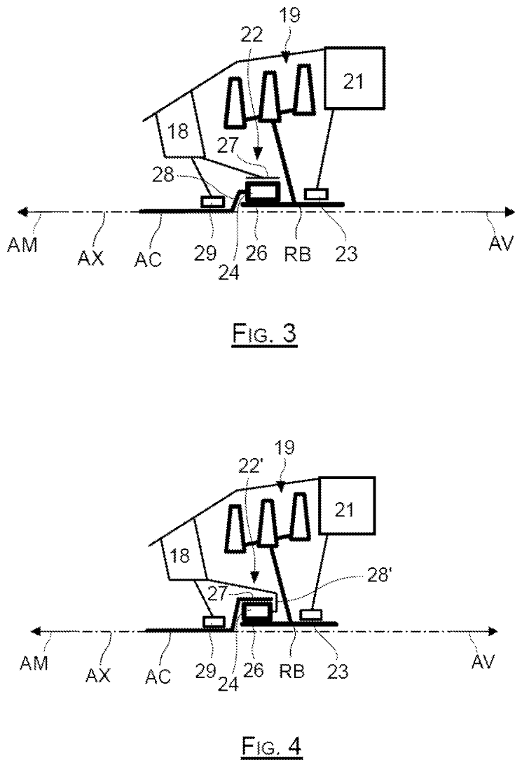

After having passed through the high-pressure turbine 17, the fluid passes into an interturbine casing marked 18 in FIG. 3, before passing through a low-pressure turbine 19, in order then to be discharged through an exhaust casing 21.

The interturbine casing 18 includes an outer collar and an inner collar concentric with each other, delimiting between them an annular space for the primary flow to pass, as well as a set of fixed radial blades each connecting the outer collar to the inner collar and making it possible to untwist the primary flow. In a similar manner the exhaust casing 21 includes an outer collar and an inner collar, concentric with each other, delimiting an annular space for the expanded primary flow to pass, as well as a set of fixed radial arms each connecting these two collars to each other.

The low-pressure turbine 19 is carried by a rotor RB extending in line downstream from the central shaft AC, and this rotor RB is connected to this central shaft AC, so as to rotate therewith, by a reduction gear 22. This reduction gear 22, which is located longitudinally between the central shaft AC and the rotor RB, ensures that the turbine 19 rotates more quickly than the fan 13, in order to improve the efficiency of the engine.

This rotor RB carrying the turbine 19 extends from a middle part by means of which it carries the discs or bladings of the low-pressure turbine, as far as an upstream part by means of which it is coupled to the reduction gear 22.

As can be seen in FIG. 3, the low-pressure rotor RB is held and guided rotationally by a downstream bearing 23, which is carried by the exhaust casing 21 and which recovers the axial thrust force generated by the low-pressure turbine to transfer it to the structure carrying the engine by means of the exhaust casing.

This reduction gear 22 includes planet gears 24 surrounding an inner ring 26, also referred to as the sun ring, and surrounded by an outer ring 27, while each being meshed with these two rings, these pinions 24 being carried by a planet carrier 28. The inner ring 26 is rigidly secured to the low-pressure rotor RB whereas the outer ring 27 is rigidly secured to the interturbine casing 18 while being carried by it. The reduction gear 22 is epicycloidal, that is to say the planet carrier 28 is able to move in rotation while being rigidly secured to the central shaft AC.

The central shaft AC is carried and guided rotationally firstly by an upstream bearing, not visible in FIG. 3, and located at the upstream part of the engine, and by a downstream central-shaft bearing 29 that is located upstream of the reduction gear 22, while being carried by the interturbine casing 18.

The example in FIG. 4 shows an embodiment having the same architecture as FIG. 3, but wherein the reduction gear, marked 22′, is a planetary reduction gear rather than epicycloidal.

This planetary reduction gear 22′ also includes planet pinions 24 surrounding an inner sun ring 26, and surrounded by an outer ring 27 while each being meshed with these two rings, these pinions 24 being carried by a planet carrier 28′. The outer ring 27 is able to move while being rigidly secured to the central shaft AC, and the inner ring 26 is carried by the low-pressure rotor RB. The planet carrier, marked 28′, is here fixed while being carried by the interturbine casing 18.

The central shaft AC is there also held firstly by an upstream bearing, not visible, and by the downstream bearing 29 carried by the interturbine casing 18 while being located upstream of the reduction gear 22′, these two bearings having the same arrangement as in the example in FIG. 3 already described.

The invention makes it possible to eliminate additional bearings usually provided for supporting the central shaft for the purpose of shifting the natural frequencies of this shaft outside its rotation frequencies. It thus makes it possible to limit the use of complex bearings such as SFD bearings, and to reduce the precision of balancing required for the central shaft.

What is claimed is:

1-5. (canceled)

6. Twin-spool turbojet engine including a central shaft (AC) surrounded by a high-pressure spool (CH) that are coaxial and independent with respect to rotation, this turbojet engine including, from upstream (AM) to downstream (AV) considered in the direction of travel of the flow that passes through it when it is in service:
a fan (13) driven by the central shaft (AC);
a high-pressure compressor (16) and a high-pressure turbine (17) forming part of the high-pressure spool (CH);
an interturbine casing (18);
a low-pressure turbine (19);
an exhaust casing (21);
this turbojet engine further including:
a low-pressure rotor (RB) extending downstream of the central shaft (AC) and which comprises the low-pressure turbine (19);
a rotor bearing (23) carried by the exhaust casing (21), and which rotationally guides the low-pressure rotor (RB);
a reduction gear (22, 22′) by means of which the low-pressure rotor (RB) drives the central shaft (AC), this reduction gear being located upstream of the rotor bearing (23);
a downstream shaft bearing (29) that rotationally guides the central shaft (AC) while being located upstream of the reduction gear (22, 22′).

7. Turbojet engine according to claim 6, wherein the downstream shaft bearing (29) is carried by the interturbine casing (18).

8. Turbojet engine according to claim 6, wherein the reduction gear (22) is an epicycloidal reduction gear comprising:
planet gears (24) carried by a planet holder (28) that is carried by the central shaft (AC);
an inner ring (26) that is carried by the low-pressure rotor (RB);
an outer ring (27) that is carried by the interturbine casing (18);
each planet gear (28) being meshed with the inner ring (26) and with the outer ring (27).

9. Turbojet engine according to claim 6, wherein the reduction gear (22′) is a planetary reduction gear comprising:
planet gears (24) carried by a planet carrier (28′) that is carried by the interturbine casing (18);
an inner ring (26) that is carried by the low-pressure rotor (RB);
an outer ring (27) that is carried by the central shaft (AC)t;
each planet gear (24) being meshed with the inner ring (26) and with the outer ring (27).

10. Turbojet engine according to claim 6, including a low-pressure compressor (14) driven by the central shaft (AC) while being located between the fan (13) and the high-pressure compressor (16).
